(19) United States
(12) Patent Application Publication
(10) Pub. No.: US 2026/0228393 A1
(43) Pub. Date: Aug. 6, 2026

(54) SYSTEM AND METHOD FOR DESIGNING A DEVICE

(71) Applicant: EATON INTELLIGENT POWER LIMITED, Dublin 4 (IE)

(72) Inventors: Srimaya PADHI, Pune Maharashtra (IN); Adi BOTEA, Dublin (IE); Karthikeyan Sundararajan CHOKAPPA, Pune Maharashtra (IN); Rhythm MEHRA, Amritsar Punjab (IN)

(21) Appl. No.: 19/155,614

(22) PCT Filed: Apr. 20, 2023
(86) PCT No.: PCT/EP2023/060239

§ 371 Date: Aug. 12, 2025

(30) Foreign Application Priority Data
Mar. 2, 2023 (IN) 202311014024

(51) Int. Cl. G06F 30/27; G06N 5/02

(52) U.S. Cl. CPC G06F 30/27; G06N 5/02

(57) ABSTRACT

Some embodiments relate to constructing a device. The device design system includes a plurality of data silos including distributed component information related to components associated with a design to be designed; a knowledge graph datastore including a knowledge graph representative of the distributed component information; and a distributed processing server in communication with the knowledge graph. The distributed processing server can be configured to receive a device design problem including one or more requirements and one or more constraints; generate a plurality of search tree queries based on the device design problem; iteratively generate a plurality of sets of solutions using the knowledge graph, each set of solutions corresponding to a respective search tree query; and generate one or more device configurations based on the one or more sets of solutions.

### CROSE-REFERENCE TO RELATED APPLICATIONS

This application is a national phase filing under 35 C.F.R. § 371 of and claims priority to PCT Patent Application No. PCT/EP2023/060239, filed on Apr. 20, 2023, which claims the benefit of Indian Application No. 202311001402, filed on Mar. 2, 2023, the contents of which are hereby incorporated in their entireties by reference.

### FIELD OF THE DISCLOSURE

The presently disclosed subject matter relates to a system and method for designing a device, and more particularly relates to a system and method for an optimized construction or assembly of a device.

### BACKGROUND TO THE DISCLOSURE

The optimized construction of a device (e.g., a gearbox) from component parts can require an evaluation of different potential scenarios, stemming from a plurality of options. For example, the options may include: combinations of parts that are compatible, combinations of materials that are compatible, and potential sources of components.

The optimized construction of a device may require analysis of a large number of scenarios, and there may be a non-insignificant time required to evaluate each scenario. Accordingly, the optimized construction of a device may face the problem of making the generation of solutions to the scenarios efficient in terms of computational time.

An additional problem may arise from the analysis of a given scenario often requiring the aggregation of knowledge or information from different information silos, wherein the information may be sequestered in different systems or subsystems. For example, information about potential sources for a given part and part material information can originally lie in two different information silos, such that the information is difficult to aggregate. A holistic view may be required in order to generate a solution to the scenarios and as such, it may be desirable to aggregate information in different information silos.

The present disclosure has been devised to mitigate at least some of the above-mentioned problems.

### SUMMARY OF THE DISCLOSURE

In accordance with a first aspect of the present disclosure, there is provided a device design system comprising: a plurality of data silos comprising distributed component information related to components associated with a design to be designed; a knowledge graph datastore comprising a knowledge graph representative of the distributed component information; and a distributed processing server in communication with the knowledge graph, the distributed processing server configured to: receive a device design problem comprising one or more requirements and one or more constraints; generate a plurality of search tree queries based on the device design problem; iteratively generate a plurality of sets of solutions using the knowledge graph, each set of solutions corresponding to a respective search tree query; and generate one or more device configurations based on the one or more sets of solutions.

The term ‘data silo’ may be understood as a first datastore that is isolated from one or more second datastores in such a manner that the data stored on the first datastore is incompatible, inaccessible, or difficult to access with respect to the second datastores.

The term ‘knowledge graph’ may be understood as a graph comprising a plurality of nodes, and a plurality of edges, each edge connecting a respective pair of nodes of the graph. The nodes may be representative of respective entities, and the edges may be representative of a relationship between the respective pair of nodes which they connect.

In some embodiments, the distributed processing server is further configured to: initialise the knowledge graph based on the requirements and constraints of the device design problem. In this way, the knowledge tree may be reduced in size, such that fewer nodes are present, before any knowledge tree searches are conducted, and thus computational resources may be saved.

In some embodiments, the distributed processing server is configured to generate a plurality of search tree queries by: generating a plurality of subproblems of the device design problem; and generating the plurality of search tree queries based on the plurality of subproblems. In this way, the device design problem may be distilled into a plurality of subproblems, each of which may have a solution in the knowledge graph. Advantageously, computational resources may be saved in reaching a global solution.

In some embodiments, the plurality of subproblems comprise one or more first subproblems and one or more second subproblems, each comprising a corresponding priority level. The priority levels may be dependent on the degree of independency of the respective subproblems. In this way, the system may generate solutions to subproblems having a lower priority level using a knowledge graph that is smaller (i.e., has fewer nodes), and thus computational resources may be saved.

In some embodiments, iteratively generating the plurality of sets of solutions comprises: (i) generating one or more first sets of solutions by solving one or more first search tree queries having a first priority level search tree query; (ii) generating a filtered knowledge graph; (iii) generating one or more second sets of solutions by solving one or more second search tree queries of a next priority level; (iv) determining that all search tree queries of the priority level have been solved; and (v) re-iterating steps (ii) to (iv) until all search tree queries have been solved.

In some embodiments, if it is determined in step (iv) that a search tree query has not been solved, the distributed server is further configured to return to step (i) and generate a different set of solutions. In this way, if it is determined that no solution is present in the knowledge graph for a particular query, the system may begin again from step (i) and follow a different pathway. Advantageously, a global solution is more likely to be reached.

In some embodiments, the distributed processing server is further configured to: generate a solution subset for each set of solutions; and generate the filtered knowledge graph using the solution subsets. In this way, the number of solutions generated for each query may be reduced, and the knowledge graph may be filtered such that fewer nodes remain, thus saving computational resources.

In some embodiments, one or more sets of solutions are generated in parallel. It will be understood that one or more sets of solutions of a particular priority level may be generated in parallel, because they are not dependent on the other solutions of the priority level. Advantageously, computational time may be reduced.

In some embodiments, the device design system further comprises: an existing solution datastore comprising one or more existing solutions, each of the one or more existing solutions being associated with a respective search tree query; and wherein the distributed processing server is further configured to: store the generated sets of solutions in the existing solution datastore as existing solutions associated with the respective search tree query; and wherein generating one or more sets of solutions comprises, for each search tree query: determining that an existing solution to the search tree query is present in the existing solution datastore; and using the existing solution as the solution to the search tree query. In this way, if a search tree query has been solved already, the set of solutions may be stored on the existing solution datastore, and a subsequent search tree query may utilise this stored set of solutions, thus saving computational resources.

In some embodiments, the distributed processing server is further configured to: rank the solutions of each set of solutions; and generate the one or more device configurations based on the ranked solutions. In this way, the system may provide a device configuration that is best suited for the device design problem.

In some embodiments, the distributed processing server is configured to receive the device design problem via an API.

In accordance with a second aspect of the present disclosure, there is provided a device design method comprising method steps of the system of the first aspect of the present disclosure.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The presently disclosed subject matter will now be described by way of example only with reference to the following Figures in which:

FIG. 1 shows a schematic view of a device design system in accordance with a first aspect of the present disclosure;

FIG. 2A shows an example knowledge graph;

FIG. 2B shows an example search tree; and

FIG. 3 shows a flow diagram of a device design method in accordance with a second aspect of the present disclosure, using the device design system of FIG. 1.

### DETAILED DESCRIPTION

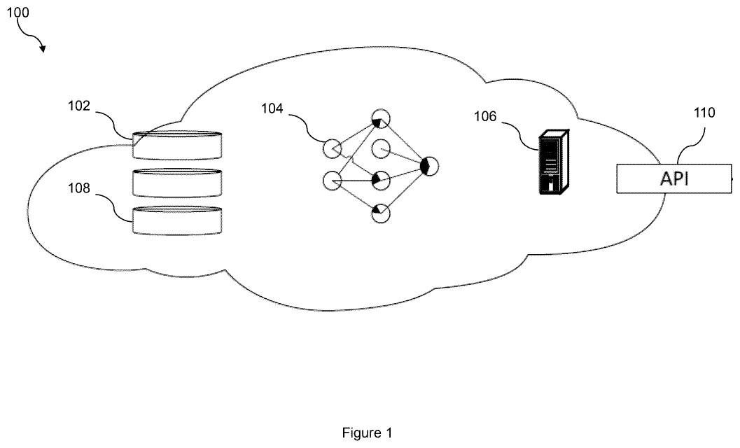

FIG. 1 shows a schematic view of a device design system 100 in accordance with a first aspect of the present disclosure. The distributed processing server 106 comprises a plurality of data silos 102; a knowledge graph datastore 104; a distributed processing server 106; an existing solution datastore 108; and an application programming interface (API) 110.

In the following example, the device design system 100 is configured to design a gearbox. The gearbox is a power transmission device comprising a case, two gears, two shafts, and four bearings.

The term ‘data silos’ may be understood as a first datastore that is isolated from one or more second datastores in such a manner that the data stored on the first datastore is incompatible with the second datastores. The plurality of data silos 102 comprise distributed component information related to entities or components associated with the device to be designed. The phrase “distributed component information” may be understood as the component information related to the components being distributed across the plurality of data silos.

In the present example, the plurality of data silos 102 comprises five data silos. A first data silo comprises a list of suppliers. The first data silo may be a single database comprising information regarding all suppliers for all types of components (for example, cases, gears, shafts, and bearings). Alternatively, the first data silo may comprise a plurality of databases, each comprising information regarding one or more suppliers for one or more types of components. A second data silo comprises bill of material data. A third data silo comprises information regarding supplier ranking in terms of their suitability. A fourth data silo comprises information regarding compatibility constraints. For example, a compatibility constraint may indicate which materials are compatible with requirements expressed in an input.

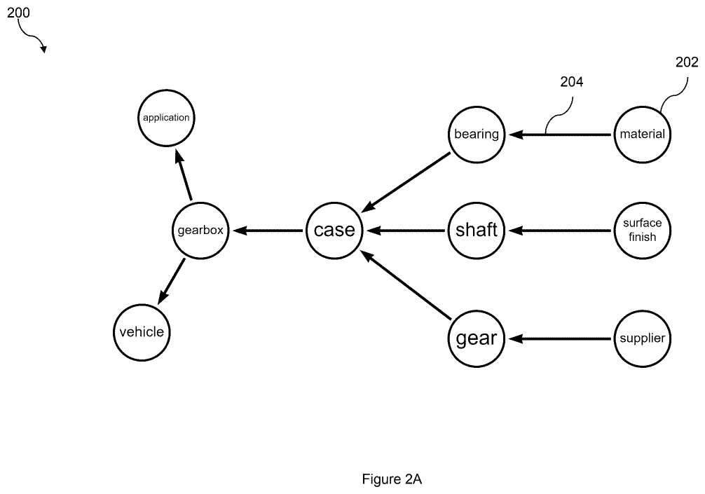

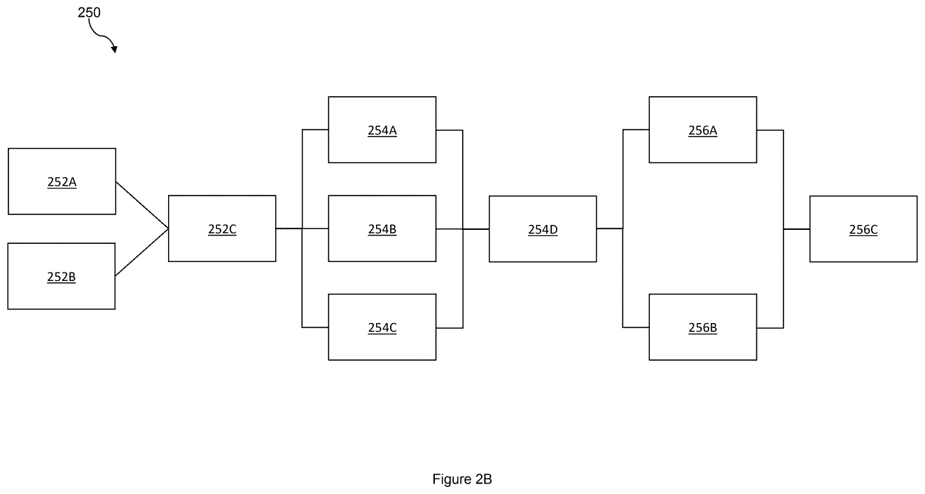

The knowledge graph datastore 104 is configured to store and maintain a knowledge graph. FIG. 2 depicts a knowledge graph 200 according to the present example. The knowledge graph 200 comprises a plurality of nodes 202, and a plurality of edges 204, each edge connecting a respective pair of nodes 202. The nodes 202 are representative of respective entities of the knowledge graph 200, and the edges 204 are representative of a relationship between the respective pair of nodes which they connect. For example, the edge 204 connecting the ‘material’ node 202 to the ‘bearing’ node 202 in FIG. 2 is indicative of a material of the bearing. The nodes 202 and edges 204 are representative of data stored in the plurality of data silos 102.

In the present example, the plurality of nodes 202 comprise: a case node; a gear node; a shaft node; a bearing node; a supplier node; a surface finish node; and a material node, although it will be appreciated that any number of nodes and entities may be present. The plurality of edges 204 comprise: a gear ratio between two gears; a supplier supplying a gear; and a material of a bearing, although it will be appreciated that any suitable number of edges may be present. The knowledge graph 200 also comprises a list of attributes, each attribute being associated with a respective node. In the present example, the list of attributes may provide information regarding relevant features of each part, such as a material of the part, a size of the part, and/or a physical shape of the part, although any number of suitable attributes may be present. It will be appreciated that the knowledge graph 200 is by way of example, and that the knowledge graph 200 may grow or change dynamically based on available data.

The existing solution datastore 108 is configured to cache solutions to previously solved search tree queries for reuse in subsequent iterations. These cached solutions may be used in subsequent iterations of the design method to save time.

The API 110 is configured to receive one or more requirements and one or more constraints from an input means (not shown). The one or more requirements are used to formulate one or more search tree queries. Example requirements include: which parts can be used; what material can be used; and/or what the source of the parts can be. The constraints are used to further define the one or more search tree queries. Example constraints include: a maximum cost; a maximum size; minimum size; and/or minimum performance. A solution to a search tree query of the one or more search tree queries optimizes the search whilst adhering to the one or more constraints.

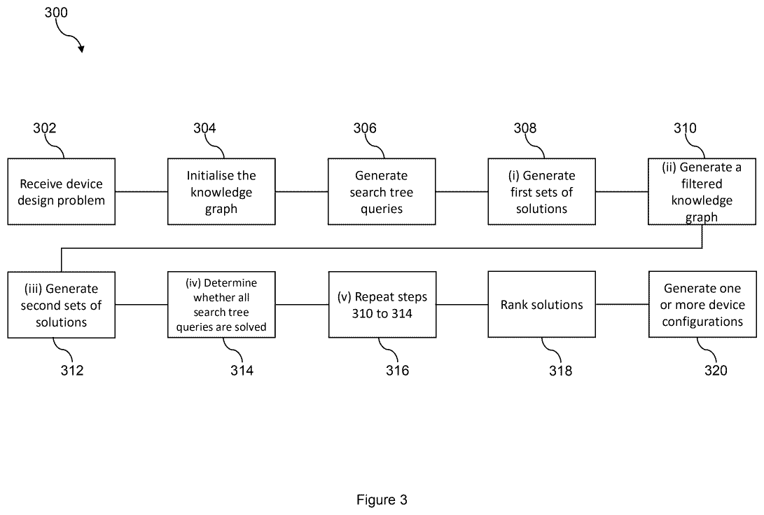

FIG. 3 shows a flow diagram of a device design method 300 in accordance with a second aspect of the present disclosure, using the device design system 100 of FIG. 1 and the knowledge graph 200 of FIG. 2.

In the present example, the device design method 300 is configured to provide an optimized gearbox design.

At step 302, the distributed processing server 106 receives a device design problem via the API 110. The device design problem defines the requirements and constraints of a target device to be designed.

A solution to the device design problem comprises a plurality of identified parts to be added to the target device. The solution also comprises relevant attributes of each part, such as a material, a size, and/or a physical shape of the respective part. The solution further comprises a source for each part. For example, a part may be sourced from a supplier, or built through additive manufacturing. The solution must satisfy the requirements and constraints received at step 302. For example, the solution must provide a combination of parts that are compatible with each other, and/or to satisfy a given quality criteria (such as minimizing a number of distinct sources for all parts), as defined by the device design problem.

In the present example, the device design problem is a gearbox design problem. The gearbox design problem comprises additional constraints for the type of vehicle and the application of the vehicle. In particular, the gearbox design problem of the present example is for designing a gearbox for a heavy-duty vehicle in an off-road application. Accordingly, the gearbox design problem comprises further requirements or constraints, such as a size of the gearbox, a number of gears of the gearbox, a maximum mass of the gearbox, and a surface finish required for a shaft of the gearbox.

At step 304, the distributed processing server 106 initialises the knowledge graph based on the requirements and constraints of the device design problem. In particular the distributed processing server 106 initialises the knowledge graph by filtering the knowledge graph based on the requirements and constraints of the device design problem as received in step 302.

In the present example, the distributed processing server 106 filters the knowledge graph such that only information compatible with heavy-duty vehicles in an off-road application are retained in the knowledge graph. For example, nodes representative of shafts that are unsuitable for use with heavy-duty vehicles in an off-road application are removed from the knowledge graph. In this way, the knowledge graph is reduced in size and computational resources may be saved in searches on the filtered graph.

At step 306, the distributed processing server 106 generates a plurality of search tree queries. In particular, the distributed processing server 106 generates a plurality of subproblems of the devise design problem, and generates the plurality of search tree queries based on the plurality of subproblems.

The distributed processor generates a plurality of subproblems comprising one or more first subproblems and one or more second subproblems of the device design problem, each subproblem comprising a corresponding priority level. The first subproblems are subproblems that are independent of other subproblems and the second subproblems are subproblems that are dependent on other subproblems. That is, the first subproblems are subproblems that can be solved without requiring another solution, such as a case subproblem. The second subproblems are subproblems that require another solution to be solved, such as a case source subproblem. Each subproblem of the one or more device design subproblems comprises one or more requirements and one or more constraints. The priority levels are dependent on the degree of independency of the respective subproblems.

In the present example, the one or more first subproblems comprise a case subproblem for determining a case which meets case constraints and case requirements, and a shaft subproblem for determining a shaft which meets shaft constraints and shaft requirements. The case subproblem and the shaft subproblem comprise a first priority level, because they are independent with respect to each other.

The one or more second subproblems comprise a gear subproblem, a bearings subproblem, a shaft source subproblem, a gear source subproblem, and a bearings source subproblem. The gear subproblem is for determining gears which meet gear constraints and gear requirements that are also compatible with the case and the shaft. The bearings subproblem is for determining bearings which meet bearing constraints and bearing requirements that are also compatible with the case and the shaft. The shaft source subproblem for determining a source for the shaft. The gear subproblem, the bearings subproblem, and the shaft source subproblem each comprise a second priority level, because they have a degree of dependency on the subproblems having the first priority level, whilst being mutually independent. In particular, the gear subproblem is dependent on the case and the shaft, the bearings subproblem is dependent on the case and the shaft, and the shaft source subproblem is dependent on the shaft. The gear source subproblem is for determining a source for the gears. The bearings source subproblem is for determining a source for the bearings. The gear source subproblem and the bearings source subproblem each comprise a third priority level, because they have a degree of dependency on the subproblems having the second priority level, whilst being mutually independent. In particular, the gear source subproblem is dependent on the gear solutions and the bearings source subproblem is dependent on the bearings solutions.

The first priority level is greater than the second priority level. The second priority level is greater than the third priority level.

It will be appreciated that there may be any number of subproblems and priority levels.

The plurality of search tree queries may be understood with respect to a search tree comprising the plurality of search tree queries, each corresponding to a respective subproblem. The search tree comprises a plurality of levels, each level corresponding to a priority level and comprising one or more branches. Each branch corresponding to a search tree query of a respective subproblem generated in step 306. Each level is ordered according to the priority level of the subproblems.

FIG. 2B depicts a search tree 250 according to the present example. A first level of the search tree 250 corresponds to the first priority level. The first level comprises a first branch having the case query 252A and a second branch having the shaft query 252B. When the first level is solved, a partial solution 252C is generated. The partial solution can be used to further filter the knowledge graph such that subsequent searches (i.e., searches of a subsequent priority level) are conducted on a smaller knowledge graph. In this way, computational resources may be saved. A second level corresponds to the second priority level. The second level comprises the gear query 254A, the bearings query 254B, and the shaft source query 254C. A solution to the second level of the search tree provides a second partial solution 254D, which can also be used to further filter the knowledge graph. A third level corresponds to the third priority level. The third level comprises the gear source query 256A and the bearings source query 256B. A solution to the second portion of the search tree provides a third partial solution 256C, which can also be used to further filter the knowledge graph in the case that there are further priority level subproblems.

In the following steps 308 to 316, the distributed processing server 106 iteratively generates a plurality of sets of solutions using the knowledge graph, each set of solutions corresponding to a respective search tree query.

At step 308, the distributed processing server 106 (i) generates one or more first sets of solutions by solving one or more first search tree queries having a first priority level. That is, the distributed processing server 106 solves the first search tree queries corresponding to the first priority level subproblems, generating a set of solutions for each search tree query. The first priority level search tree queries may be solved sequentially or in parallel. The distributed processing server 106 can generate the solutions by searching the knowledge graph using strategies such as a breadth-first search, a depth-first search, and a best-fit search.

In the present example, the distributed processing server 106 solves the case subproblem and the shaft subproblem in the first iteration.

The distributed processing server 106 may generate a solution subset for each of the search tree query solutions. In particular, the distributed processing server 106 generates a solution subset for each set of solutions, comprising fewer solutions than the respective full set of solutions. The solution subset may comprise n solutions, and n may be predetermined by a user. For example, the user may select n=10 and as such, the distributed processing server 106 generates solution subsets comprising up to 10 solutions. Each solution of the solution subset is generated by applying a cost function to the respective set of solutions.

The following method steps 310 to 314 are iterative.

At step 310, the distributed processing server 106 (ii) generates a filtered knowledge graph. In particular, the distributed processing server 106 removes nodes of the knowledge graph that are only connected to nodes that are not part of the sets of solutions. In this way, the distributed processing server 106 creates a filtered knowledge graph having fewer nodes and edges than the knowledge graph. This filtering of the knowledge graph leads to an increase of computational efficiency because the time taken to solve a subsequent set of plurality of search tree queries is reduced. Furthermore, the distributed processing server 106 reduces a size of the knowledge graph in multiple dimensions in a single iteration.

In the present example, in a first iteration of step 310, the distributed processing server 106 removes nodes of the knowledge graph that are only connected to nodes that are not connected with nodes associated with the case and the shaft solutions determined in step 310, before solving the one or more subproblems at the second priority level.

At step 312, the distributed processing server 106 (iii) generates one or more second sets of solutions by solving one or more second search tree queries of the next priority level. In particular, the distributed processing server 106 iteratively solves the one or more second search tree queries according to their priority level, wherein each search tree query of a particular priority level is solved in parallel.

In the present example, in a first iteration of step 314, the distributed processing server 106 solves the one or more second search tree queries of the second priority level. In the present example, the distributed processing server 106 solves the gear search tree query, the bearings search tree query, and the shaft source search tree query. The gear solution provides gears which meet gear constraints and gear requirements. The bearings solution provides bearings which meet bearing constraints and bearing requirements. The shaft source solution provides shaft sources. Since only nodes that are compatible with the preceding solutions are left in the filtered knowledge graph, each solution is compatible with the preceding solutions.

The distributed processing server 106 may generate a solution subset for each of the sets of solutions. In particular, the distributed processing server 106 generates a solution subset for each set of solutions, comprising fewer solutions than the respective full set of solutions. The solution subset may comprise n solutions, and n may be predetermined by a user. For example, the user may select n=10 and as such, the distributed processing server 106 generates solution subsets comprising up to 10 solutions. Each solution of the solution subset is generated by applying a cost function to the respective set of solutions. In this way, in a next iteration, the knowledge graph will be filtered such that only nodes connected to the nodes corresponding to the solution subsets are considered.

In the present example, the gear solution subset provides 10 gears which meet gear constraints and gear requirements. The bearings solution subset provides 10 bearings which meet bearing constraints and bearing requirements. The shaft source solution subset provides 10 shaft sources.

At step 314 the distributed processing server 106 (iv) determines whether all search tree queries of the priority level have been solved. In particular, the distributed processing server 106 determines that all subproblems of the priority level provide at least one solution.

If it is determined that at least one subproblem of the priority level is not solved, the method returns to step 308, and a new set of solutions generated. For example, if it determined that there is no solution to the shaft source search tree query (indicative of there being no source for the shaft of the shaft solution), the method may return to step 310 and start again with a different solution to the shaft subproblem.

If steps 310 to 314 are repeated until there are no longer any solutions remaining (i.e., there are no remaining possible branches of the search tree), the search tree query cannot be solved with the current knowledge graph. In this case, an error message may be displayed to the user.

At step 316, the distributed processing server 106 (v) repeats steps 310 to 314 until all search tree queries have been solved. In a new iteration, the distributed processing server 106 uses the solutions that have been generated in the preceding iterations. Accordingly, in the present example, the distributing processing server 106 repeats steps 310 to 314 using the case solution, the shafts solution, the gears solution, the bearings solution, and the shaft source solution. In this way, every subsequent iteration (i.e., when solving search tree queries of a subsequent priority level) is performed on a knowledge graph that is reduced in size.

Optionally, steps 310 and 314 also comprise storing the first sets of solutions and/or the second sets of solutions in the existing solution datastore 108 as existing solutions associated with the respective subproblem. In this way, the distributed processing server 106 can solve a search tree query that has already been solved, using the existing solutions of the existing solution datastore 108. That is, the distributed processing server 106 can determine the solution to a search tree query by first determining whether an existing solution is present in the existing solution datastore 108. This may find particular utility when, for example, it is determined in step 314 that at least one search tree query cannot be solved, because the distributed processing server 106 may re-use a solution of a previous iteration.

At step 318, the distributed processing server 106 ranks the solutions to each of the subproblems. In particular the distributed processing server 106 ranks the solutions to each of the subproblems using a cost function. Since the number of solutions to each search tree query may be reduced to n in step 308 and/or step 312, up to n solutions are ranked for each search tree query in step 318.

In the present example, the cost function may be a weighted sum. The cost function may be a cumulative mass for all components of a particular configuration, a quality of material, and/or a mechanical loss in power transmission.

At step 320, the distributed processing server 106 generates one or more device configurations. In particular, the distributed processing server 106 generates one or more device permutations, each permutation comprising a solution to each of the subproblems. The device configurations comprise manufacturing and sourcing details, thereby providing a means for manufacturing and sourcing a particular device configuration. For example, the device configuration may comprise manufacturing and sourcing details indicative of choices of parts, suppliers, materials, and plants, although it will be appreciated that the manufacturing and sourcing details may comprise any relevant details.

Alongside the device configurations, the distributed processing server 106 outputs a Bill of Materials comprising the manufacturing and sourcing details.

A user of the device design system 100 may therefore execute the device design method 300 to generate a device configuration suitable for their requirements and constraints.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device design system comprising:
a plurality of data silos comprising distributed component information related to components associated with a design to be designed;
a knowledge graph datastore comprising a knowledge graph representative of the distributed component information; and
a distributed processing server in communication with the knowledge graph, the distributed processing server configured to:
receive a device design problem comprising one or more requirements and one or more constraints;
generate a plurality of search tree queries based on the device design problem;
iteratively generate a plurality of sets of solutions using the knowledge graph, each set of solutions corresponding to a respective search tree query; and
generate one or more device configurations based on the one or more sets of solutions.

2. The device design system of claim 1, wherein the distributed processing server is further configured to:
initialise the knowledge graph based on the requirements and constraints of the device design problem.

3. The device design system of claim 1, wherein the distributed processing server is configured to generate a plurality of search tree queries by:
generating a plurality of subproblems of the device design problem; and
generating the plurality of search tree queries based on the plurality of subproblems.

4. The device design system of claim 3, wherein the plurality of subproblems comprise one or more first subproblems and one or more second subproblems, each comprising a corresponding priority level.

5. The device design system of claim 1, wherein iteratively generating the plurality of sets of solutions comprises:
(i) generating one or more first sets of solutions by solving one or more first search tree queries having a first priority level search tree query;
(ii) generating a filtered knowledge graph;
(iii) generating one or more second sets of solutions by solving one or more second search tree queries of a next priority level;
(iv) determining that all search tree queries of the priority level have been solved; and
(v) re-iterating steps (ii) to (iv) until all search tree queries have been solved.

6. The device design system of claim 5, wherein, if it is determined in step (iv) that a search tree query has not been solved, the distributed server is further configured to return to step (i) and generate a different set of solutions.

7. The device design system of claim 5, wherein the distributed processing server is further configured to:
generate a solution subset for each set of solutions; and
generate the filtered knowledge graph using the solution subsets.

8. The device design system of any of claim 5, wherein the one or more sets of solutions are generated in parallel.

9. The device design system of claim 5, further comprising:
an existing solution datastore comprising one or more existing solutions, each of the one or more existing solutions being associated with a respective search tree query; and
wherein the distributed processing server is further configured to:
store the generated sets of solutions in the existing solution datastore as existing solutions associated with the respective search tree query; and
wherein generating one or more sets of solutions comprises, for each search tree query:
determining that an existing solution to the search tree query is present in the existing solution datastore; and
using the existing solution as the solution to the search tree query.

10. The device design system of claim 1, wherein the distributed processing server is further configured to:
rank the solutions of each set of solutions; and
generate the one or more device configurations based on the ranked solutions.

11. The device design system of claim 1, wherein the distributed processing server is configured to receive the device design problem via an API.

12. A device design method comprising:
receiving a device design problem comprising one or more requirements and one or more constraints;
generating a plurality of search tree queries based on the device design problem;
iteratively generating a plurality of sets of solutions, each set of solutions using the knowledge graph, each set of solutions corresponding to a respective search tree query; and
generating one or more device configurations based on the one or more sets of solutions.

13. The device design method of claim 12, further comprising:
initialising the knowledge graph based on the requirements and constraints of the device design problem.

14. The device design method of claim 12, wherein generating the plurality of search tree queries comprises:
generating a plurality of subproblems of the device design problem; and
generating the plurality of search tree queries based on the plurality of subproblems.

15. The device design system of claim 14, wherein the plurality of subproblems comprise one or more first subproblems and one or more second subproblems, each comprising a corresponding priority level.

16. The device design method system of claim 1, wherein iteratively generating the plurality of sets of solutions comprises:
(i) generating one or more first sets of solutions by solving one or more first search tree queries having a first priority level search tree query;
(ii) generating a filtered knowledge graph;
(iii) generating one or more second sets of solutions by solving one or more second search tree queries of a next priority level;
(iv) determining that all search tree queries of the priority level have been solved; and
(v) re-iterating steps (ii) to (iv) until all search tree queries have been solved.

17. The device design method of claim 16, wherein, if it is determined in step (iv) that a search tree query has not been solved, the method returns to step (i) and generate a different set of solutions.

18. The device design system of claim 16, further comprising:
generating a solution subset for each set of solutions; and
generating the filtered knowledge graph using the solution subsets.

19. The device design method of claim 15, further comprising:
storing the generated sets of solutions in an existing solution datastore as existing solutions associated with the respective search tree query; and
wherein generating one or more sets of solutions comprises, for each search tree query:
determining that an existing solution to the search tree query is present in the existing solution datastore; and
using the existing solution as the solution to the search tree query.

20. The device design method of claim 12, further comprising:
ranking the solutions of each set of solutions; and
generating the one or more device configurations based on the ranked solutions.
